(19) United States
(12) Patent Application Publication
(10) Pub. No.: US 2013/0226392 A1
(43) Pub. Date: Aug. 29, 2013

(54) SYSTEMS AND METHODS FOR ADVISING CUSTOMERS REGARDING VEHICLE OPERATION AND MAINTENANCE

(71) Applicants: Eric W. Schneider, Shelby Township, MI (US); Daniel Hicks Blossfeld, Novi, MI (US); Donald John Smolenski, Grosse Pointe, MI (US); Eric R. Johnson, Brighton, MI (US)

(72) Inventors: Eric W. Schneider, Shelby Township, MI (US); Daniel Hicks Blossfeld, Novi, MI (US); Donald John Smolenski, Grosse Pointe, MI (US); Eric R. Johnson, Brighton, MI (US)

(73) Assignee: GM GLOBAL TECHNOLOGY OPERATIONS LLC, Detroit, MI (US)

(21) Appl. No.: 13/408,110

(22) Filed: Feb. 29, 2012

(51) Int. Cl. G01M 15/04

(52) U.S. Cl. 701/29.5

(57) ABSTRACT

Systems and methods for system for encouraging compliance with a recommendation related to engine oil of a vehicle. The system includes a computer-readable medium having instructions causing a processor to (A) determine that a communication regarding the engine oil life should be sent providing at least one datum of (i) information considered in generating the communication, (ii) a predicted result of following the recommendation, being a first predicted result, (iii) a predicted result of not following the recommendation, being a second predicted result, (iv) a message including a positive remark, being a first message, and (v) a message including a remark identifying an improvement that can be made, being a second message. The method can also include (B) sending the communication from the processor to a destination.

### TECHNICAL FIELD

The present disclosure relates generally to systems and methods for advising customers regarding vehicle operation and maintenance and, more particularly, to systems and methods for generating and providing such advice in connection with a vehicle parameter, such as engine oil, based on input data, and for selectively affecting vehicle operation based on the data.

### BACKGROUND

Some modern automobiles have oil monitoring systems. The systems provide the customer, e.g., driver or owner of a rental vehicle, with an indication of when an oil change is needed. The indication is in some cases simply a light or visual message provided when the system determines that it is time to change the oil. Advance notice of a needed oil change can also be communicated to the customer in the form of a percentage of oil life remaining until a recommended oil change.

An example standard for changing oil is to change the oil while there is between 0% and about 5% oil life remaining. It has been determined, though, that only about one-third of customers follow such standard, even after receiving indications of oil life remaining from conventional monitoring systems.

There is a need for technology that will better influence customer behavior. There is also a need for ways to use oil monitoring systems to achieve benefits including lowering negative effects on the environment, saving money for the customer, extending oil life, and improving vehicle health.

### SUMMARY

The present disclosure in one aspect relates to systems and methods for encouraging compliance with a recommendation related to engine oil of a vehicle. An example system includes at least one computing processor and at least one computer-readable medium. The medium has instructions that, when executed by the processor, cause the processor to perform acts of a method.

The method can include determining that a communication regarding the engine oil life should be sent providing at least one datum selected from a group of data consisting of (i) information considered in generating the communication, (ii) a predicted result of following the recommendation, being a first predicted result, (iii) a predicted result of not following the recommendation, being a second predicted result, (iv) a message including a positive remark, being a first message, and (v) a message including a remark identifying an improvement that can be made, being a second message. The method can also include sending the communication from the processor to a destination.

In one aspect, the present disclosure relates to a system and method for encouraging compliance with a recommendation related to engine oil of a vehicle. The system can include a computing processor and a computer-readable medium having instructions that, when executed by the processor, cause the processor to perform a method.

The method of this aspect can include (a) determining a primary reason for oil degradation including determining, based on oil life information, which of at least three pre-determined characteristics of engine oil life has a lowest value. The method can further include (b) providing, if it is determined that a first characteristic of the pre-determined characteristics has the lowest value, a first communication to a destination. The method can also include (c) providing, if it is determined that a second characteristic of the pre-determined characteristics has the lowest value, a second communication to the destination, and (d) providing, if it is determined that a third characteristic of the pre-determined characteristics has the lowest value, a third communication to the destination.

Other aspects of the present invention will be in part apparent and in part pointed out hereinafter.

### DESCRIPTION OF THE DRAWINGS

FIG. 1 illustrates a schematic block diagram of a system for implementing the present technology according to an embodiment of the present disclosure.

FIG. 2 illustrates schematically an automobile, including an onboard computer unit and peripheral components, according to an embodiment of the present disclosure.

FIG. 3 illustrates schematically a remote processing center, including a computer system and a customer-service feature, according to an embodiment of the present disclosure.

FIG. 4 illustrates a method for determining whether the oil has been changed and communicating with the customer in the event that it has, according to an embodiment of the present disclosure.

FIG. 5 illustrates a method for determining a primary source of oil degradation and communicating with the customer regarding same, according to an embodiment of the present disclosure.

FIG. 6 is a graph showing example values for combustion events (Y-axis) versus mileage (X-axis) for vehicles driven according to three general driving habits.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to employ the present disclosure.

Overview of the Disclosure

In various embodiments, the present disclosure describes computer-implemented methods and related systems for generating, and providing to customers, or users, or to devices associated with them, advice regarding vehicle operation with a goal of affecting vehicle maintenance and/or operation. The advice relates to at least one vehicle parameter, such as engine oil.

For efficiency of description and readability, the present disclosure focuses primarily on the systems and methods of the present technology in connection with engine oil as the vehicle parameter, and with an automobile as the vehicle. The technology of the present disclosure, though, is not limited to use in connection with engine oil or even automobiles. And the technology can be used in connection with other vehicle parameters, including those requiring regular maintenance, such as transmission fluid. The technology can also be used with any type of vehicle, such as aircraft and watercraft.

In the context of engine oil as the vehicle parameter, methods and systems of the present disclosure provide vehicle-specific information beyond just a percentage of oil life remaining. The information is communicated to the customer in one or more of a variety of ways including by way of an onboard display and e-mail.

It has been determined that customers are more likely to follow a recommendation when provided with supporting or other information related to the recommendation. Such information can be referred to as the intelligence of the algorithm, where the algorithm represents the process of determining the recommendation.

In other words, a customer is more likely to follow a recommendation when the customer is advised of (I) the data (e.g., variables) that went into determining the recommendation and/or (II) results or consequences of (A) following the recommendations or (B) their driving and/or oil-change habits relating to the recommendations, versus being notified only of the recommendation. The results or consequences can be past or present, regarding the customer's past driving and/or oil changing habits, and/or can be future, expected, or predicted effects.

According to the present technology, communications can include (i) already-occurred results or consequences, (ii) presently-occurring results or consequences, and/or (iii) future or predicted results or consequences (i.e., past, present, and/or future) associated with the customer's past and/or present driving and/or oil-changing habits.

For example, if a customer has changed his oil within the recommended guidelines, the customer may get a congratulatory message thereby encouraging the driver to continue the same behavior. As an example of future or predicted effects, the system could explain to the customer that the “observed short-trip driving and little highway driving will result in an earlier oil change.” In the latter example, ancillary information could include monetary, vehicular, or environmental results.

Information that can be provided to the customer includes recommendations and positive feedback regarding driving habits, type of oil, and timing of an oil change performed. The information can also communicate particular effects that the customer's driving and/or oil-changing behavior has had or could potentially have on vehicle-related factors, such as engine oil life and vehicle health, and external factors, such as the environment and saving money for the customer.

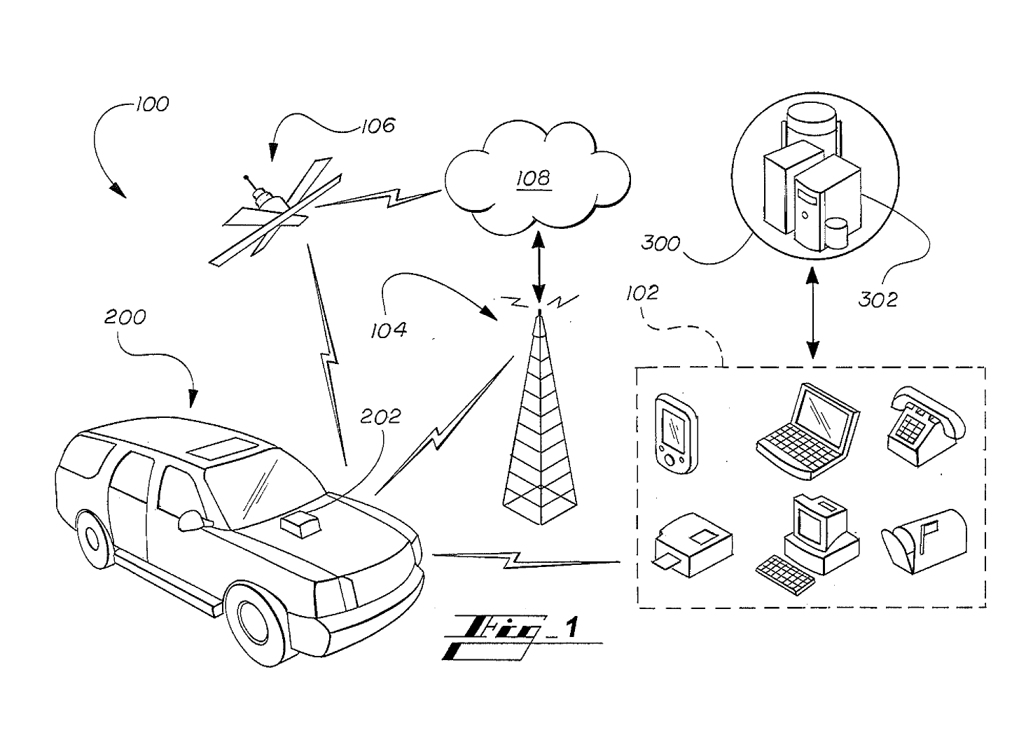

FIG. 1

Now turning to the figures, and more particularly to the first figure, FIG. 1 illustrates a schematic block diagram of a system 100 for implementing the present technology. The system 100 includes several parts, which may be combined in any combination to form one or more sub-systems of the system 100.

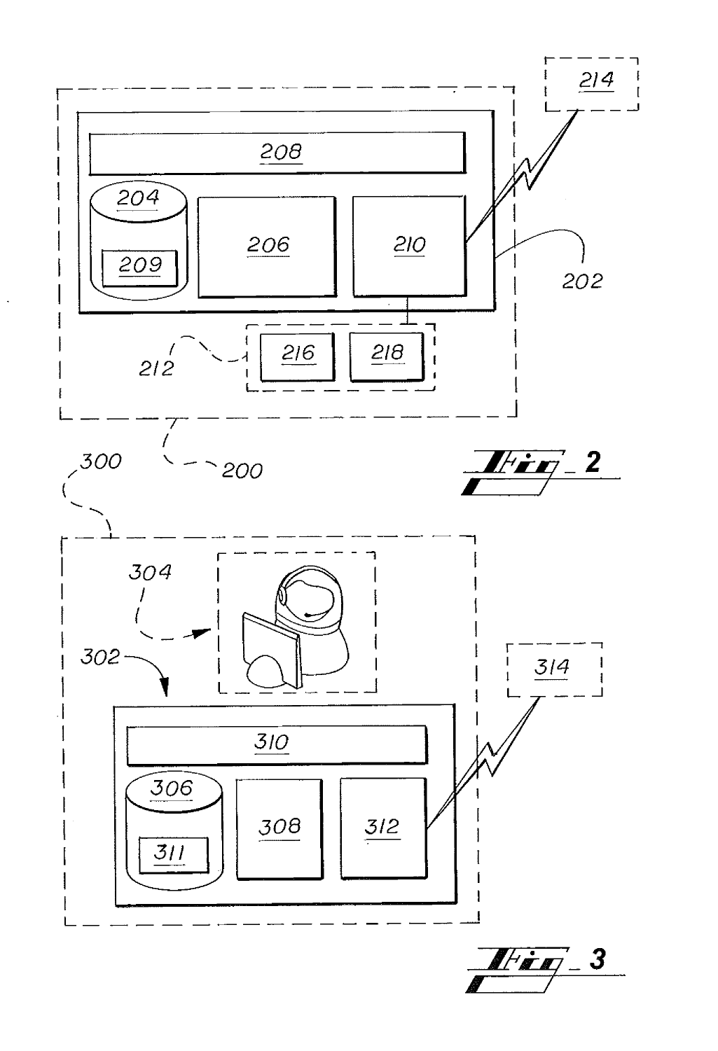

As shown in FIG. 1, the system 100 includes a vehicle 200 having an onboard computer unit 202. As described below in connection with FIG. 2, the OCU 202 monitors and controls various components of the vehicle.

The system 100 also includes a remote operating or processing center 300. The remote processing center 300 includes a computer 302, such as a computer server. The processing center 300, which in some embodiments includes customer-service personnel, may be, include, or be a part of a monitoring system such as the OnStar® monitoring system of the General Motors Company. The OnStar® system provides numerous services including hands-free calling, turn-by-turn navigation, in-vehicle safety and security, and remote-diagnostics.

Although a single computer 302 is described herein, primarily, it will be appreciated that the remote processing center 300 can include any number of computers, connected and/or independent, in the same and/or various geographic locations. Communications sent from the remote processing center 300 may be initiated by the computers 302 or an operator of the center 300, such as personnel at the center 300 (e.g., a monitoring-center operator).

With continued reference to FIG. 1, various customer communication devices 102 are shown. The devices 102 illustrated are merely examples of devices by which the messages can be communicated to the customer according to the present technology. The devices represented by example in the illustration include mobile communications devices, generally, smart phones, tablet computers, laptop computers, personal computers, facsimiles, and traditional mail systems. Example, types of messages sent to the devices 102 include e-mails, short-messaging system (SMS) messages, multimedia-messaging system (MMS) messages, voice messages, facsimiles, and paper.

And as indicated above, and below in more detail, messages can also be communicated to the OCU 202 for implementation at the vehicle 200 and/or communication to the user, such as by way of a vehicle display (represented generally by reference numeral 218 in FIG. 2).

The system 100 also includes, or interacts with, a communication sub-system. The communication sub-system facilitates communications between any or all of the vehicle 200, the remote processing center 300, and the devices 102. The communication sub-system includes any of a variety of communications components including a remote access point 104, a satellite system 106, and a communications network 108.

The remote access point 104 can include, for example, a base station for cellular communications network, an infrastructure access point (e.g., roadside transceiver), and/or other transceivers (receivers and/or transmitters). The access point 104 could also represent other vehicles in the context of vehicle-to-vehicle (v2v) communications.

The remote access point 104 and the satellite system 106 can communicate directly or indirectly with a communications network 108. The communications network 108 can be a packet-switched network (e.g., Internet, for packetized data transfer) and/or a circuit-switched network (for phone traffic).

In some embodiments, the OCU 202, and at least one user device 102 are configured to interface directly with each other via short-range communication. Example short-range communication protocols include WI-FI®, BLUETOOTH®, infrared, infrared data association (IRDA), near field communications (NFC), Dedicated Short-Range Communications (DSRC), the like, and improvements thereof (WI-FI is a registered trademark of WI-FI Alliance, of Austin, Tex., and BLUETOOTH is a registered trademark of Bluetooth SIG, Inc., of Bellevue, Wash.).

FIG. 2

FIG. 2 illustrates schematically features of the vehicle 200 shown in FIG. 1. As shown, the onboard computer unit 202 includes a memory, or computer-readable medium 204, such as volatile medium, non-volatile medium, removable medium, and non-removable medium. The term computer-readable media and variants thereof, as used in the specification and claims, refer to tangible, non-transitory, storage media.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The OCU 202 also includes a computer processor 206 connected or connectable to the computer-readable medium 204 by way of a communication link 208, such as a computer bus.

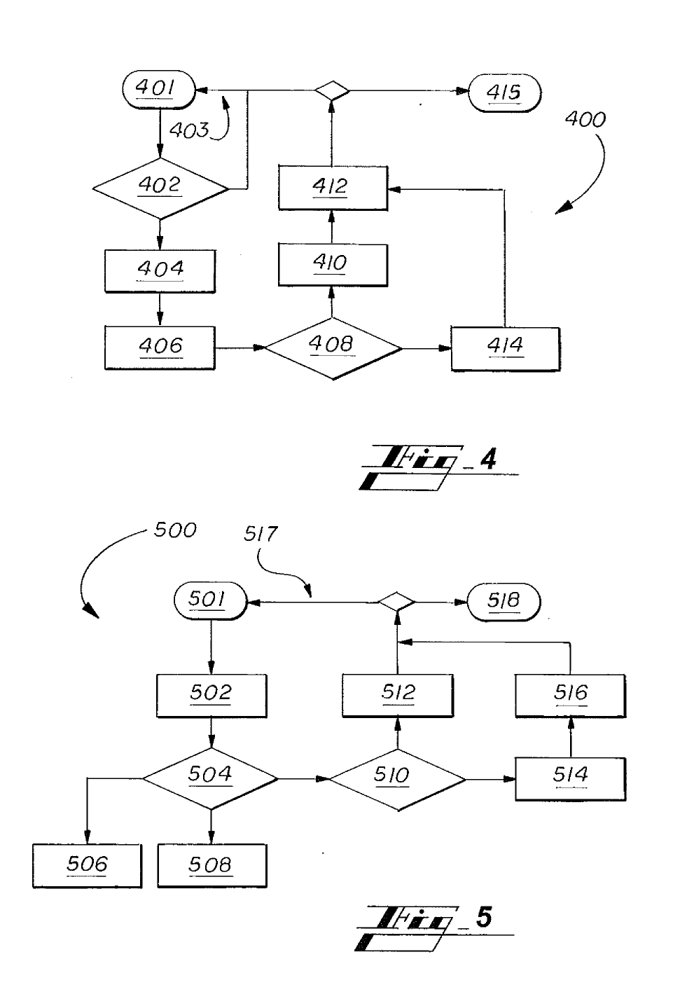

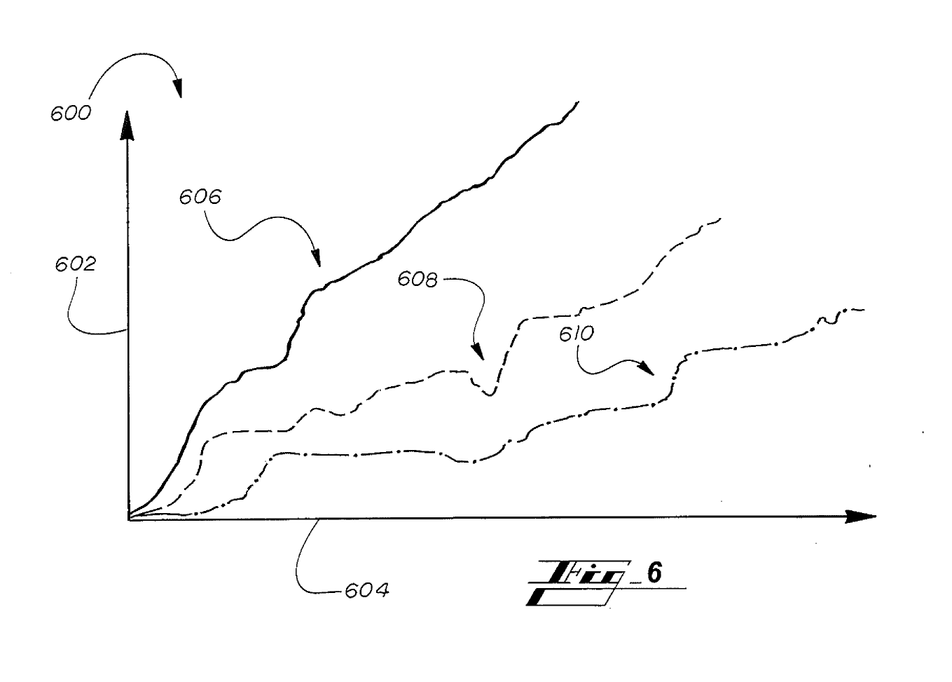

The computer-readable medium 204 includes computer-executable instructions 209. The computer-executable instructions 209 are executable by the processor 206 to cause the processor, and thus the OCU 202, to perform any combination of the functions described in the present disclosure. These functions are described, in part, below in connection with FIGS. 4 and 5.

The computer-executable instructions are a part of the oil monitoring system, being configured to perform the acts described herein regarding operation of the system.

The computer-executable instructions 209 can be arranged in one or more software modules. The modules can be referred to by the act or acts that they cause the processor 206 to perform. For instance, a module including instructions that, when executed by the processor 206, cause the processor to perform a monitoring step can be referred to as a monitoring module. Similarly, a module causing the processor to generate a message (e.g., “an e-mail stating, “Congratulations for changing your oil according to the system recommendations.”) can be referred to as a generating module, a generation module, a message generation module, or the like.

The term software module, or variants thereof, is used expansively herein to include routines, program modules, programs, components, data structures, algorithms, and the like. Software modules can be implemented on various system configurations, including servers, network systems, single-processor or multiprocessor systems, minicomputers, mainframe computers, personal computers, hand-held computing devices, mobile devices, microprocessor-based, programmable consumer electronics, combinations thereof, and the like.

The processor 206 is also connected or connectable to at least one interface 210 for facilitating communications, between the OCU 202 and other vehicle components 212, and between the OCU and nodes 214 external to the vehicle, such as those shown in FIG. 1 (items 102-106).

Although shown as being a part of the OCU 202, completely, the interface 210, or any aspect(s) thereof, is partially or completely a part of the OCU 202. The interface 210, or any aspect(s) thereof, can be partially or completely external to and connected or connectable to the OCU. For communicating with the external nodes 214, the interface 210 includes one or both of a short-range transceiver and a long-range transceiver.

The other vehicle components 212 include various devices acting as inputs and/or outputs for the OCU 202. The other vehicle components 212 include at least one sensor 216 associated with at least one vehicle parameter. The parameter includes, in various embodiments, one or more of engine oil, transmission fluid, or another vehicle feature for which the customer selectively arranges maintenance. Regarding engine oil, the sensor 216 can include one or more of (i) an engine oil level sensor, (ii) an engine oil temperature sensor, (iii) a water-contamination sensor for measuring an amount (e.g., percentage or units) of water dilution, or contamination, of the oil, (iv) an oxidation sensor for measuring a level of oxidation of the engine oil (v) a fuel-contamination sensor for measuring an amount of fuel (e.g., gasoline) dilution, or contamination, of the oil, (vi) a viscosity sensor, for measuring a level of oil viscosity of the engine oil, and (vii) an electrochemical oil quality sensor, for measuring an electro-chemical characteristic of the engine oil.

The sensors 216 can also include those associated with measuring travel distance (e.g., mileage) of the vehicle. Such sensors include an odometer, or other devices for providing data related to an amount of vehicle travel, such as wheel sensors or parts of a global-positioning system.

Other example sensors 216 are those measuring engine conditions, such as real-time performance. In some embodiment, these sensors include those measuring engine combustion activity, such as a number of combustion events per unit time (e.g., per minute, hour, day, etc.).

In a contemplated embodiment, a single sensor performs two or more of the sensing functions described herein.

In some embodiments, the other vehicle components 212 include a vehicle-user interface 218. The vehicle-user interface 218 includes at least one input and/or at least one output device. An example output device is a display, such as a dashboard, overhead, or head-up display. The display could be a part of an instrument panel also including readouts for speed, engine temperature, etc. The display in some cases includes one or more light-emitting diodes (LEDs) or other lighting parts.

An example output device is a speaker for providing audible messages to the customer. The audible messages can be verbal (e.g., “An Oil change has been detected”) or non-verbal, such as a tone, beep, ring, buzz, or the like. The OCU 202 is in some embodiments configured to provide both audible and visual communications to the customer, such as substantially simultaneously in connection with the same event (e.g. oil change detected).

In one contemplated embodiment, the vehicle-user interface 218 includes a haptic technology. The haptic technology facilitates communications to the user by way of vibrations or in other touch-related ways. For instance, the OCU 202 could, in conjunction with a visual oil system-related message, cause a steering wheel to vibrate.

In some embodiments, the at least one vehicle-user interface 218 is both an input and output device, such as a touch-screen display.

The vehicle-user interface 218 can also include a microphone for receiving instructions or other information from the customer. The microphone can also be considered as one of the sensors 216.

FIG. 3

FIG. 3 illustrates schematically features of the remote operating center 300, or processing center, shown in FIG. 1. As indicated above, the remote processing center 300 includes one or more computers 302. If more than one, the computers 302 are, in various embodiments, completely, partially, or not at all co-located.

The remote processing center 300 in some embodiments also includes customer-service personnel and devices they use (e.g., phones, computers, etc.), collectively indicated in FIG. 3 by reference numeral 304. As also indicated above, the processing center 300 may be, include, or be a part of a monitoring system such as the OnStar® system.

As shown in FIG. 3, the at least one remote processing center computer 302 includes a memory, or computer-readable medium 306, such as volatile medium, non-volatile medium, removable medium, and non-removable medium. Types of computer-readable media are described above with respect to the computer 202 of FIG. 2.

The remote processing center computer 302 also includes a processor 308. The processor 308 is connected or connectable to the computer-readable medium 306 by way of a communication link 310, such as a computer bus.

The computer-readable medium 306 includes computer-executable instructions 311. The computer-executable instructions 311 are executable by the processor 308 to cause the processor, and thus the remote processing center computer 302, to perform any combination of the functions described in the present disclosure. These functions are described, in part, below in connection with FIGS. 4 and 5.

The computer-executable instructions 311 can be arranged in one or more software modules. The modules can be referred to by the act or acts that they cause the processor 308 to perform. This naming convention is described above in connection with the instructions stored at the onboard computer unit 202.

The processor 308 is also connected or connectable to at least one interface 312 for facilitating communications, between the remote processing center computer 302 and nodes 314 external to the remote processing center computer 302, such as those shown in FIG. 1 (items 102-108).

Although shown as being a part of the remote processing center computer 302, the interface 312, or any aspect(s) thereof, is partially or completely a part of the remote processing center computer 302. The interface 312, or any aspect(s) thereof, can be partially or completely external to and connected or connectable to the remote processing center computer 302. For communicating with the external nodes 314, the interface 312 includes one or both of a short-range transceiver and a long-range transceiver.

FIG. 4

FIG. 4 shows an exemplary method 400 for determining whether the oil in the vehicle 200 has been changed, and communicating with the customer in the event that it has, according to an embodiment of the present disclosure. It should be understood that the steps of the method 400 are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims.

It should also be understood that the illustrated method 400 can be ended at any time. In certain embodiments, some or all steps of this process, and/or substantially equivalent steps are performed by a processor, such as the processor 206 or 308, executing computer-readable instructions stored or included on a computer readable medium, such as the memory 204 of the onboard computer unit 202 and/or the memory 306 of the remote processing center computer 302. In the case of the remote processing center 300, the instructions/operations are in some cases a part of a vehicle diagnostics system, such as an OnStar® Vehicle Diagnostics (OVD) system.

The method 400 begins 401 and flow proceeds to block 402, whereat a processor, such as the processor 206 of the computer unit 202 of the vehicle, 200, executing computer-readable instructions, determines whether an oil change has occurred. For making this determination, the processor considers one or more inputs. In one embodiment, the input includes readout from one of the vehicle sensors 216. In a particular embodiment, the input includes at least one sensor readout selected from a group of readouts consisting of oil level received from an oil-level sensor.

In some embodiments, the determination act 402 includes receiving input initiated by a technician (e.g., user or auto shop technician) resetting an oil life switch/selecting an oil changed switch of the oil life system. In some embodiments the determination is based on information received from or at the engine oil life system, which obtains or generates the information indicating that the oil has been changed. An exemplary engine oil life system for use by and/or in the present technology is the Engine Oil Life System (EOLS) of General Motors®.

The determination act 402 can be performed generally continuously, such as at regular intervals with small increments between performances, such as 1 second, 10 seconds, 1 minute, 10 minutes, or at longer intervals. In one embodiment, the determination act 402 is performed in response to a query, such as a query for information regarding the oil system received from the remote processing center 300. In one embodiment, the query is generated locally, at the onboard computing unit.

With continued reference to FIG. 4, in response to determining that the response to determining that the oil has been changed, at step 404 the processor updates the oil monitoring system to reflect that oil life for the vehicle has increased.

The acts related to determining that an oil change has occurred can occur in various order, and with other steps. For example, in one embodiment, the relevant computer-executable instructions are configured so that the processor determines that the oil life for the vehicle has increased, such as by sensor readouts described above (e.g., oil-level readouts), and the act of determining that an oil change has been made is performed is triggered by the determination that the oil life for the vehicle has increased.

In one embodiment, the oil monitoring system maintains an oil change reset, such as a value or a switch. An oil change reset action is performed in response to the processor determining that the oil life for the vehicle has increased, such as by sensor readouts described above (e.g., oil-level readouts), or vice versa (i.e., the oil life for the vehicle is determined to be increased in response to a determination that the oil change reset action has been performed).

The act of determining that the oil has been changed (act 404) is, in various embodiments, made in response to (i) the sensor readouts, as described, or (iii) the determination that the oil life has increased, as described.

If at act 402 it is determined that an oil change has not been made, flow of the method can return, along path 403, to its beginning 401. As part of returning 403 to the start 401, the processor may communicate current values for various oil system variables, such as any one or more of a date on which an oil change should be made, a mileage at which an oil change should be made, a number of miles until the oil should be changed, and a time factor relating to when the oil should be changed (e.g., a number of days until the oil should be changed). The information is in some embodiments communicated to the user by way of one or more of the vehicle-user interfaces 218 described above, such as a dashboard, overhead, or head-up display.

If at act 402, it is determined that an oil change has been made, flow proceeds to block 404 whereat the processor determines or estimates values for various system variables, such as a value for a time, an odometer reading, and an oil life remaining following the oil change. The processor in various embodiments updates the oil monitoring system with any or all of this data.

At block 406, the processor notifies the customer that the oil monitoring system has detected that the oil change was made. The notification may also include or accompany notification to the customer of any or all of the values for system variables following the oil change.

At decision block 408, the processor determines whether the oil life remaining at the time of the oil changes (e.g., not long before the oil change), was within or close to the recommended range for making the oil changes, such as by being between about 5% and 0%. The actual change could be performed disadvantageously after the recommended range has passed (i.e., oil life has already reached 0%), but could also be performed disadvantageously before the recommended range is entered (i.e., oil life has not yet fallen to 5%; the 5% value being only an example of a top end of a range). This function helps toward alleviating scenarios by which oil-change providers sway customers to change their oil too early.

If at act 408 it is determined that the oil change was not performed in the recommended range, flow proceeds to block 410 whereat the processor communicates a first communication or message to the customer. The terms communication and message are at times used interchangeably in the present disclosure.

The first communication is in some embodiments communicated to the user by way of one or more of the vehicle-user interfaces 218 described above, such as a dashboard, overhead, or head-up display.

In some embodiments, delivery of the communication is initiated at the remote processing center 300, such as by a processor 308 thereof. The processor 308 in some embodiments delivers the communication by way of the one or more of the vehicle-user interfaces 218. In some cases, the processor 308, alternatively or in addition, delivers the communication to the customer by channels other than the vehicle-user interfaces, such as by any of the various customer communication devices 102 described above in connection with FIG. 1.

In some embodiments, the communication is provided by way of periodic reports, such as monthly reports available to the customer over the Internet by way of a web site/page and/or via e-mail. These same reports, generated at the vehicle 200 and/or remote processing center 300, can be provided to the customer via the in-vehicle interfaces 218.

As provided, the devices 102 shown and described are merely examples of devices by which communications can be communicated to the customer and can include communications devices, generally, smart phones, tablet computers, laptop computers, personal computers, facsimiles, and traditional mail systems. Example, types of communications sent to the devices 102 include e-mails, short-messaging system (SMS) messages, multimedia-messaging system (MMS) messages, voice messages, facsimiles, and paper.

In some embodiments, the communication or message is generated and transmitted in response to a triggering event. The triggering event can be, for instance, determination of an oil change being needed, being done, having been recently done.

Another example triggering event is the customer requesting such feedback, such as by contacting the remote processing center 300. The customer can make this contact, and therein request such information, by way of the vehicle 200 or the customer communication devices 102. In cases in which the communication is generated and delivered from the remote processing center 300, personnel 304 could receive the triggering communication from the customer and initiate generation and/or transmission of the communication to the customer. As provided, the instructions/operations of the remote center 300 are in some cases a part of a vehicle diagnostics system, such as an OnStar® Vehicle Diagnostics (OVD) system.

The first communication or message in some embodiments includes information or data used in determining one or more of (i) that the communication should be sent, (ii) contents of the communication, and (iii) contents of a recommendation related to oil life (e.g., regarding timing of an oil change or quality of oil to be used). For example, the communication can include one or more readouts from any of the sensors 216. As another example, the communication can include aspects of an algorithm used to generate the recommendation or the communication.

The first communication is in some embodiments configured to motivate the customer from a less-than-perfect performance to a better performance in terms of timing for obtaining oil changes. As an example, the message could state, “An oil change has been detected” (this portion of the message could be part of step 406) and “Could do better, thereby saving money, protecting the environment, and increasing vehicle health.” An example of benefiting the environment is reducing oil waste by less frequent oil changes.

Saving money is just one example of the types of financial considerations that can be communicated. The financial considerations communicated could include in more detail the ability for the user to save money by avoiding the need for more oil changes, or the converse of the user having to spend extra money in connection with additional oil changes. An example of a environment-related consideration that can be communicated to the user includes advising the user of past, present, and/or future (e.g., predicted) effects that their good or bad habits have had/are having/will have on the environment (e.g., gallons of waste oil avoided, amount of energy at refineries saved, fuel saved by avoiding trips to oil-changing shop, other quantifiable metrics, etc.). An example of a vehicle health consideration that can be communicated includes an indication or information relating to damage that can be caused by highly-degraded and/or contaminated oil, or relating to the converse benefits of not operating the vehicle with such bad oil in it.

In one embodiment, the oil monitoring system in some embodiments stores a variety of communications corresponding to various circumstances. The communication presented to the customer at block 410 is in some embodiments selected by the processor from among the stored communications based on information such as a relationship between a percentage of oil life remaining at about the time of the oil change and the recommended range for changing oil (e.g., 0% to 5% of oil life remaining). Some of the communications can range from more aggressive/more negative messages to less aggressive/more positive messages and depend on the circumstance.

For instance, one message may state, “Your oil was changed with 25% oil life remaining; The recommended range for changing oil is 0% to 5%; You did fine and could do a little better thereby saving money and helping the environment,” and another could more aggressively state, “Your oil was changed with 50% oil life remaining; The recommended range for changing oil is 0% to 5%; You should consider making less frequent oil changes, thereby saving money and helping the environment.”

In a contemplated embodiment, the method 400 includes, following a determination that the oil was changed outside of the recommended range, a block 412 including detecting a quality of oil input in the oil change. The block 412 in some embodiments also includes communicating a second communication or message to the customer regarding the quality of oil detected. The second communication is in some embodiments communicated to the user by way of one or more of the vehicle-user interfaces 218 described above, such as a dashboard, overhead, or head-up display.

In various embodiments, delivery of the communication is otherwise triggered, generated, and/or delivered in any of the ways described above regarding the triggering, generation, and delivery of communications. For instance, the message can be delivered, in response to any of various triggering events, from the vehicle 200 and/or the remote processing center 300 to any of the various customer communication devices 102 described above in connection with FIG. 1.

In one embodiment, the second communication is selected from a group of communications depending on the quality of oil detected. If the recommended oil is detected, for instance, a very positive second message is communicated, accordingly, and so on.

The detection act of block 412 is in some embodiments performed using input from one or more of the vehicle sensors 216. Relevant sensors 216 can include one or more of (i) an engine oil level sensor, (ii) an engine oil temperature sensor, (iii) a water-contamination sensor for measuring an amount (e.g., percentage or units) of water dilution, or contamination, of the oil, (iv) an oxidation sensor (v) a fuel-contamination sensor for measuring an amount of fuel (e.g., gasoline) dilution, or contamination, of the oil, (vi) a viscosity sensor, or (vii) an electrochemical oil quality sensor.

Returning to decision block 408, if it is determined there that the oil change was performed in the recommended range, flow proceeds to block 414 whereat the processor communicates a third communication to the customer. The third communication is in some embodiments communicated to the user by way of one or more of the vehicle-user interfaces 218 described above, such as a dashboard, overhead, or head-up display.

In various embodiments, delivery of the communication is otherwise triggered, generated, and/or delivered in any of the ways described above regarding the triggering, generation, and delivery of communications. For instance, the communication can be delivered, in response to any of various triggering events, from the vehicle 200 and/or the remote processing center 300 to any of the various customer communication devices 102 described above in connection with FIG. 1.

The third communication is in some embodiments configured to congratulate the customer on a good performance and/or otherwise motivate them to continue the good performance in regards to timing of future oil changes. As an example, the message could state, “An oil change has been detected” (this portion of the message could be part of step 406) and “Great job, the oil was changed within the recommended range of oil life remaining 0% to 5%, thereby saving money, protecting the environment, and maintaining vehicle health.”

As provided, in one embodiment, the oil monitoring system in some embodiments stores a variety of communications corresponding to various circumstances. The third communication presented to the customer at block 414 is in some embodiments selected by the processor from among the stored communications based on information such as a relationship between a percentage of oil life remaining at about the time of the oil change and the recommended range for changing oil. Some of the communications can range from more positive to less positive and depend on the circumstance.

From block 414, flow may then proceed to block 412 including detecting a quality of oil input in the oil change and communicating the second communication to the customer regarding the quality of oil detected.

From block 412, flow can proceed to the beginning 401 of the method 400 whereby the method 400 is performed again. As part of returning to the beginning, the processor may perform the acts described above in connection with return path 403—i.e., communicating to the customer, by way of one or more of the vehicle-user interfaces 218, current values for various oil system variables, such as any one or more of: the date on which the next oil change should be made, a mileage at which the next oil change should be made, a number of miles until the next oil should be changed, and the time factor relating to when the oil should be changed (e.g., the number of days until the oil should be changed).

Alternatively, the method 400 can end 415 after the act(s) of block 412 and/or after the act(s) of blocks 410 and 414.

FIGS. 5 and 6

FIG. 5 shows an exemplary method 500 for determining a primary reason for degradation of engine oil between oil changes, and providing a communication to the customer depending on the findings, according to an embodiment of the present disclosure. As with the method 400 of FIG. 4, it should be understood that the steps of the method 500 are not necessarily presented in any particular order and that performance of some or all the steps in an alternative order is possible and is contemplated.

The steps have been presented in the demonstrated order for ease of description and illustration. Steps can be added, omitted and/or performed simultaneously without departing from the scope of the appended claims. It should also be understood that the illustrated method 500 can be ended at any time.

In certain embodiments, some or all steps of this process, and/or substantially equivalent steps are performed by a processor, such as the processor 206 or 308, executing computer-readable instructions stored or included on a computer readable medium, such as the memory 204 of the onboard computer unit 202 and/or the memory 306 of the remote processing center computer 302. In the case of the remote processing center 300, the instructions/operations are in some cases a part of a vehicle diagnostics system, such as an OnStar® Vehicle Diagnostics (OVD) system.

The method 500 begins 501 and flow proceeds to block 502, whereat a processor, such as the processor 206 of the computer unit 202 of the vehicle, 200, executing computer-readable instructions, maintains oil life information regarding various characteristics or features of engine oil life. In some embodiments, the features include contamination, oxidation, and time (e.g., calendar time). Contamination relates to an amount of contamination in the oil, such as an amount of fuel contamination or water contamination. Oxidation relates an amount of oxidation of the oil. The time relates to an amount of time (e.g., calendar time, calendar days, etc.) remaining until an oil change is/was recommended.

The information includes various values, each value corresponding to a respective one of the various features. Each value represents a level or percentage of oil life remaining according to the respective feature. For instance, while engine oil life may be estimated as 50% remaining considering in connection with oil contamination (i.e., the value for oil life regarding contamination is 50%), the oil life may be estimated as 40% in connection with oxidation of the oil, and 55% in terms of estimated remaining calendar time.

Thus, the various oil degradation processes are not additive. For example, someone may have 50% oil life remaining from oxidation, 40% based on time, alone, but 20% life remaining from contamination. In this example, only the contamination factor is considered a predominant factor, which is described further below.

It has been estimated that determining the predominant reasons for oil degradation will at least slightly and in some cases significantly increase intervals between oil changes for most customers (e.g., up to about 40%-50% increase). For instance, knowing a primary factor requiring an oil change, the system can recommend vehicle maintenance and/or vehicle operation habits that can reduce effects of the predominant factor, thereby increasing future oil change intervals. By identifying the predominant factor for degradation, corrective action can be identified and recommended to the customer (e.g., by the center computer 302 and/or vehicle computer 202), such as improved driving habits/patterns and use of a better type of oil.

The systems described herein (e.g., the center computer 302 and/or vehicle computer 202) are in some embodiments configured to initiate (e.g., automatically initiate) a change in operation of the vehicle 200 in response to any of the determinations disclosed herein, including those of block 502. For instance, for cases in which it is determined that a customer is operating the vehicle 200 primarily for short trips (versus, e.g., a mostly-highway driving pattern), and fuel contamination is the predominant reason for oil degradation, the software of the system(s) described herein can instruct the driver to change oil to provide needed engine protection. For fuel dilution, this protects against loss of adequate bearing film thickness. Increased fuel dilution reduces oil viscosity, and oil viscosity determines oil film thickness in journal bearings. Film thickness that is too low (low viscosity) will cause bearing failure.

As another example, for cases in which it is determined that a customer is operating the vehicle 200 primarily for short trips and water contamination is the predominant reason for oil degradation, the software of the system(s) described herein can instruct the driver to change oil to provide needed engine protection against rust and corrosion.

Oil life can also be increased in response to the detection of an oil addition by the customer.

Data for use in the acts of block 502 is in some embodiments received from one or more of the vehicle sensors 216.

At block 504, the method includes an act of determining, based on the oil life information, which of the various features of engine oil life have a lowest value—e.g., level or percentage. The feature identified in this step is determined to be the primary reason for oil degradation at the time. As provided, example features include contamination, oxidation, and time (e.g., calendar time). The features, though, can include others features in addition to and/or instead of any of these three example features.

The determination act 504 can be performed generally continuously, such as at regular intervals with small increments between performances, such as 1 second, 10 seconds, 1 minute, 10 minutes, or at longer intervals. In one embodiment, the determination act 504 is performed in response to a trigger, such as a trigger received from the remote processing center 300. In one embodiment, the trigger is generated locally, at the onboard computing unit.

If at block 504, it is determined that contamination is a primary reason for degradation, flow of the method 500 proceeds to step 506 whereat the processor provides to the customer a first communication or message. The first communication is in some embodiments communicated to the user by way of one or more of the vehicle-user interfaces 218 described above, such as a dashboard, overhead, or head-up display.

As described above in connection with communication generation and delivery, and triggering the same, in connection with the method 400 of FIG. 4, in some embodiments of the present method 500 as well, delivery of the communication is initiated at the remote processing center 300, such as by a processor 308 thereof. The processor 308 in some embodiments delivers the communication by way of the one or more of the vehicle-user interfaces 218. In some cases, the processor 308, alternatively or in addition, delivers the communication to the customer by channels other than the vehicle-user interfaces, such as by any of the various customer communication devices 102 described above in connection with FIG. 1.

In some embodiments, the communication is provided by way of period reports, such as monthly reports available to the customer over the Internet by way of a web site/page and/or via e-mail. These same reports, generated at the vehicle 200 and/or remote processing center 300, can be provided to the customer via the in-vehicle interfaces 218.

As provided, the devices 102 shown and described are merely examples of devices by which communications can be communicated to the customer and can include communications devices, generally, smart phones, tablet computers, laptop computers, personal computers, facsimiles, and traditional mail systems. Example, types of communications sent to the devices 102 include e-mails, short-messaging system (SMS) messages, multimedia-messaging system (MMS) messages, voice messages, facsimiles, and paper.

In some embodiments, the message is generated and transmitted in response to a triggering event. The triggering event can be, for instance, determination of an oil change being needed, being done, having been recently done.

Another example triggering event is the customer requesting such feedback, such as by contacting the remote processing center 300. The customer can make this contact, and therein request such information, by way of the vehicle 200 or the customer communication devices 102. In cases in which the message is generated and delivered from the remote processing center 300, personnel 304 could receive the triggering communication from the customer and initiate generation and/or transmission of the message to the customer. As provided, the instructions/operations of the remote center 300 are in some cases a part of a vehicle diagnostics system, such as an OnStar® Vehicle Diagnostics (OVD) system.

The first communication or message is in some embodiments configured to advise the customer of one or more ways to decrease oil degradation due to contamination. As an example, the message could state, “You are taking a lot of short trips without full warm-up. When you drive for an extended period, thereby warming up your engine oil, you may extend your oil life.”

As provided, the oil monitoring system in some cases stores a variety of communications corresponding to various circumstances. The communication presented to the customer at block 506 is in some embodiments selected by the processor from among the stored communications based on information such as a level of oil degradation—e.g., degradation due to contamination. Some of the communications can range from less positive messages to more positive messages and depend on the circumstance.

Returning to block 504, if it is determined that time is a primary reason for degradation, flow of the method 500 proceeds to step 508 whereat the processor provides to the customer a second communication. The second communication is in some embodiments communicated to the user by way of one or more of the vehicle-user interfaces 218 described above, such as a dashboard, overhead, or head-up display.

In various embodiments, delivery of the communication is otherwise triggered, generated, and/or delivered in any of the ways described above regarding the triggering, generation, and delivery of communications. For instance, the communication can be delivered, in response to any of various triggering events, from the vehicle 200 and/or the remote processing center 300 to any of the various customer communication devices 102 described above in connection with FIG. 1.

The second communication is in some embodiments configured to advise the customer of one or more ways to congratulate the customer and/or otherwise motivate them to continue the positive performance achieved by obtaining oil changes in a preferred manner, thereby minimizing cost, affects on the environment, and negative effects on vehicle health. As an example, the second message could state, “Congratulations: You are putting very little stress on your engine oil, and achieving a maximum oil change interval.”

As provided, the oil monitoring system in some embodiments stores a variety of communications corresponding to various circumstances. The second communication presented to the customer at block 508 is in some embodiments selected by the processor from among the stored communications based on information such as a level of oil degradation due to time. Some of the second communications can range from less positive messages to more positive messages and depend on the circumstance.

Returning again to block 504, if it is determined that oxidation is a primary reason for degradation, flow of the method 500 proceeds to decision block 510 whereat the processor obtains an average or actual temperature penalty factor for the vehicle 200 over a period of time, e.g., since the last oil change, the last about month, two months, or three months, etc. The average or actual temperature penalty factor can be referred to generally as simply an actual penalty factor—i.e., the actual penalty factor can be an average.

A penalty factor is factor indicating a temperature of the oil during vehicle operation. The factor can be, for example, a value distinct, but related to, an temperature (measured, e.g., in Celsius or Fahrenheit) of the oil.

In block 510, the processor also compares the average or actual temperature penalty factor to a normal or target temperature penalty factor. The normal or target penalty factor can be referred to as a threshold temperature penalty factor.

In one embodiment, the threshold temperature penalty factor is 1 corresponding to a single combustion event that would occur if the oil is at a temperature of about 110° C. or below. In a particular embodiment, the penalty factor increases in a stepwise exponential fashion with temperature—e.g., the factor is 2, 4, 8, etc., as temperature increases.

If at block 510 the processor determines that the average penalty factor is above the normal penalty factor, then flow for the method 500 proceeds to block 512 whereat the processor provides a third communication to the customer. The third communication is in some embodiments communicated to the user by way of one or more of the vehicle-user interfaces 218 described above, such as a dashboard, overhead, or head-up display.

In various embodiments, delivery of the communication is otherwise triggered, generated, and/or delivered in any of the ways described above regarding the triggering, generation, and delivery of messages. For instance, the message can be delivered, in response to any of various triggering events, from the vehicle 200 and/or the remote processing center 300 to any of the various customer communication devices 102 described above in connection with FIG. 1.

The third communication is in some embodiments configured to advise the customer that the vehicle 200 is being driven under conditions more severe than normal and that oil life will be reduced accordingly. For instance, stop-and-go or city driving at high ambient temperatures are considered more severe, or more harsh, as is any driving (even highway) when the vehicle is pulling a trailer, and driving in mountainous regions.

As provided, the oil monitoring system in some cases stores a variety of communications corresponding to various circumstances. The third communication presented to the customer at block 512 is in some embodiments selected by the processor from among the stored messages. Some of the second messages stored, and selected, can range from less positive messages to more positive messages and depend on the circumstances, such as how close or far the average or actual penalty factor is from the normal penalty factor.

If at block 510 the processor determines that the average penalty factor is not above the normal penalty factor, then flow for the method 500 proceeds to block 514 whereat the processor tries to identify one or more driving patterns that the vehicle 200 has exhibited over the a period of time (e.g., since the last oil change, the last about month, two months, or three months, etc.). Example driving patterns are HIGHWAY driving, CITY driving, and STOP/GO driving.

In one embodiment, the instructions, executed by the processor, cause the processor to, in analyzing the driving pattern(s) of the vehicle 200, consider event data indicating events of the engine of the vehicle, such as a combustion events. The instructions also cause the processor to consider odometer data indicating the distance traveled by the vehicle 200.

In a combustion engine (e.g., internal combustion engine), a combustion event involves a cycle or stroke of a cylinder of the vehicle engine. In one embodiment, a combustion event involves each of the cylinders going through their respective cycles or strokes a single time, whereby the engine as a whole is considered to have performed a single cycle or event. In some embodiments, the event and mileage data are obtained by the processor directly or indirectly from sensors 216 associated with the engine and an odometer of the vehicle 200, respectively.

In a particular embodiment, the processor, in analyzing the driving pattern(s) of the vehicle, considers a manner by which a number and/or a rate of combustion events indicated by the combustion-event data relates to (e.g., changes with) distance traveled by the vehicle as indicated by the odometer data. In this embodiment, the processor compares (A) an actual number and/or rate of combustion events versus odometer data to (B) typical number and/or rate of combustion events versus distance (e.g., mileage) for each of various driving patterns—e.g., HIGHWAY driving, CITY driving, and STOP/GO driving.

With further reference to the figures, FIG. 6 is a graph showing a typical number of events (e.g., combustion events)—Y axis (602) against a distance (e.g., mileage), such as form an odometer reading—X axis (604). From this information (events versus distance), whether the information is visualized as a graph by the processor, rates of events with distance, or a change of a number of events per unit(s) distance) can be readily determined.

Particularly, FIG. 6 shows example event-versus-distance data for each of STOP/GO driving 606, CITY driving 608, and HIGHWAY driving 610. As shown in the figure, a STOP/GO driving 606 scenario requires the most combustion events of the group, and HIGHWAY driving 610 requires the most, with CITY driving 608 requiring an amount intermediate the other two.

Returning to FIG. 5, at block 514, the processor determines which one or more of multiple driving scenarios the operation of the vehicle 200 most-closely matches. In embodiments in which processor determines a single scenario that the recent driving most-closely matches, that scenario can be referred to as a predominant driving pattern.

In one embodiment, the processor ranks scenarios of various applicable driving scenarios. For instance, the processor determines that the driving habits included mostly CITY driving, followed by HIGHWAY, followed by STOP/GO driving, in terms of amount of each.

Flow for the method 500 proceeds to step 516. At step 516, the processor provides a fourth communication or message to the customer. The fourth message is in some embodiments communicated to the user by way of one or more of the vehicle-user interfaces 218 described above, such as a dashboard, overhead, or head-up display.

In various embodiments, delivery of the message is otherwise triggered, generated, and/or delivered in any of the ways described above regarding the triggering, generation, and delivery of messages. For instance, the message can be delivered, in response to any of various triggering events, from the vehicle 200 and/or the remote processing center 300 to any of the various customer communication devices 102 described above in connection with FIG. 1.

The fourth message is in some embodiments configured to advise the customer of the type of driving that the vehicle 200 has been driven with—e.g., HIGHWAY driving, CITY driving, and/or STOP/GO driving. In a contemplated embodiment, the type of driving is a combination of various types of driving. For example, the fourth message could read, “The vehicle has been driven 50% HIGHWAY driving, 10% CITY driving, and 40% STOP/GO driving.” The message in some cases includes an indication of a relevant time period, e.g., “Since your last oil change, the vehicle has been driven 50% HIGHWAY driving, 10% CITY driving, and 40% STOP/GO driving.”

The fourth message in some embodiments advises the customer of an action that has been or will be performed in connection with operation of the vehicle 200. As an example, the fourth message could provide something to the effect of, “Your driving shows a predominantly ______ (insert HIGHWAY/CITY/STOP-GO) pattern. The engine oil life system is adjusting your oil change interval to optimize your specific oil change interval.”

As provided, the oil monitoring system stores a variety of messages corresponding to various circumstances. Some of the fourth messages stored, and selected, can range from less positive messages to more positive messages and depend on the circumstances, such as amounts of HIGHWAY, CITY, and STOP/GO driving.

From block 516, flow can proceed to the beginning 501 of the method 500 whereby the method 500 is re-performed. As part of returning to the beginning, the processor may perform the acts described above in connection with return path 517—i.e., communicating to the customer, by way of one or more of the vehicle-user interfaces 218, current values for various oil system variables, such as any one or more of the date on which the next oil change should be made, a mileage at which the next oil change should be made, a number of miles until the next oil should be changed, and a time factor relating to when the oil should be changed (e.g., a number of days until the oil should be changed). Alternatively, the method 500 can end 518 after the act(s) of block 512 and/or after the act(s) of blocks 516.

### CONCLUSION

Various embodiments of the present disclosure are disclosed herein. The disclosed embodiments are merely examples that may be embodied in various and alternative forms, and combinations thereof. For instance, methods performed by the present technology are not limited to the methods 400, 500 described above in connection with FIGS. 4 and 5.

The following list shows example data that can be made available to the acting processor(s), such as the processor 206 of the vehicle 200 and/or the processor 308 of the remote processing center 300, for performing functions of the present technology:
1. Calendar date;
2. Odometer reading (e.g., miles);
3. Oil life remaining (e.g., percentage);
4. Engine oil additions since last change (e.g., quarts);
5. Oil life remaining—Oxidation (e.g., percentage of oil oxidation);
6. Oil life remaining—H₂O (e.g., percentage of water contamination);
7. Oil life remaining—Fuel (e.g., percentage of fuel contamination);
8. Oil life remaining—Time (e.g., days remaining per a calendar function);
9. Calculated oil level deficit (e.g., Liters (L));
10. Oil quality factor (e.g., a number or a percentage);
11. Average temperature penalty factor since last oil change (e.g., a number);
12. Total combustion events since last oil change (e.g., a number);
13. Distance traveled since last oil change/oil life reset (e.g., mileage);
14. Time since last oil change/oil life reset (e.g., days);
15. Engine temperature at certain times/mileage and/or over time/mileage; and
16. Vehicle speed at certain times/mileage and/or over time/mileage.

The technologies of the present disclosure can also be used in connection with management of vehicles in a fleet. For instance, the systems described herein, including the remote processing center 300 and/or multiple vehicles 200, can provide the operator of the fleet with the information (e.g., messages) described herein. Associated fleet-management software can be provided to process the information received, for initiating and facilitating decision making by the operator concerning the vehicles in the fleet. For instance, information could be provided to, and/or fleet-management software provisioned in, one or more of the customer devices 102.

The law does not require and it is economically prohibitive to illustrate and teach every possible embodiment of the present claims. Hence, the above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

1. A system, for encouraging compliance with a recommendation related to engine oil of a vehicle, comprising:
a computing processor; and
a computer-readable medium having instructions that, when executed by the processor, cause the processor to perform acts comprising:
determining that a communication regarding the engine oil life should be sent providing at least one datum selected from a group of data consisting of:
information considered in generating the communication;
a predicted result of following the recommendation, being a first predicted result;
a predicted result of not following the recommendation, being a second predicted result;
a message including a positive remark, being a first message; and
a message including a remark identifying an improvement that can be made, being a second message; and
sending the communication from the processor to a destination.

2. The system of claim 1, wherein:
the system further comprises a vehicle sensor for sensing a characteristic related to the engine oil of the vehicle; and
the acts further comprise generating the communication; and
the information considered in generating the communication corresponds to at least output of the vehicle sensor.

3. The system of claim 1, wherein the acts further comprise generating the communication.

4. The system of claim 3, wherein the information considered in generating the communication corresponds to at least a manner by which the vehicle has been driven.

5. The system of claim 4, wherein the information indicates whether the vehicle has been driven under severe conditions.

6. The system of claim 3, wherein the information considered in generating the communication corresponds to at least a manner by which the engine oil of the vehicle has been changed.

7. The system of claim 6, wherein the information provides at least one indication selected from a group of particular indications consisting of:
a type of oil added to the vehicle as part of an oil change; and
a timing of the oil change.

8. The system of claim 7, wherein the timing is represented as at least one of:
a mileage value;
a calendar time value; and
a percentage of oil life remaining at a time of the oil change.

9. The system of claim 1, wherein the information considered in generating the communication relates to at least one consideration selected from a group of particular considerations consisting of:
a financial consideration;
health of the vehicle; and
the environment.

10. (canceled)

11. The system of claim 1, wherein the destination includes at least one particular destination selected from a group of particular destinations consisting of:
an operator of the vehicle;
a person managing the vehicle;
an owner of the vehicle;
a person working at as personnel a remote processing center;
a vehicle-user interface;
a computerized device associated with the operator of the vehicle;
a computerized device associated with the owner of the vehicle;
a computerized device associated with the person managing the vehicle; and
a computerized device associated with said personnel.

12. The system of claim 1, wherein the sending includes providing the communication by way of at least one channel selected from a group of particular channels consisting of:
an in-vehicle display;
e-mail;
mobile-phone text message;
regular mail;
web page; and
facsimile.

13. The system of claim 1, wherein the acts further comprise sending the recommendation to a receiving entity associated with the vehicle.

14. The system of claim 13, wherein the receiving entity includes at least one particular destination selected from a group of particular receiving entities consisting of:
an operator of the vehicle;
a person managing the vehicle;
an owner of the vehicle;
a vehicle-user interface;
a person working at as personnel a remote processing center;
a computerized device associated with the operator of the vehicle;
a computerized device associated with the owner of the vehicle;
a computerized device associated with the person managing the vehicle; and
a computerized device associated with said personnel.

15. The system of claim 1, wherein an entirety of the system is part of the vehicle.

16. The system of claim 1, wherein:
the determining is a first determining act;
the acts further comprise a second determining act including determining that an oil change has been performed on the vehicle; and
the first determining act is performed in response to the second determining act.

17. A system, for encouraging compliance with a recommendation related to engine oil of a vehicle, comprising:
a computing processor; and
a computer-readable medium having instructions that, when executed by the processor, cause the processor to perform a method comprising:
determining a primary reason for oil degradation including determining, based on oil life information, which of at least three pre-determined characteristics of engine oil life has a lowest value;
providing, if it is determined that a first characteristic of the pre-determined characteristics has the lowest value, a first communication to a destination; and
providing, if it is determined that a second characteristic of the pre-determined characteristics has the lowest value, a second communication to the destination; and
providing, if it is determined that a third characteristic of the pre-determined characteristics has the lowest value, a third communication to the destination.

18. The system of claim 17, wherein the at least three pre-determined characteristics include:
oil contamination;
oil oxidation; and
time.

19. The system of claim 17, wherein a nature of the third message depends on a relationship between an actual temperature penalty factor related to engine oil life for the vehicle and a threshold temperature penalty factor related to engine oil life.

20. A method, for encouraging compliance with a recommendation related to engine oil of a vehicle, comprising:
determining, at a non-transitory processor, that a communication regarding the engine oil life should be sent providing at least one datum selected from a group of data consisting of:
information considered in generating the communication, wherein the information relates to at least one input selected from a group of input consisting of:
output of a vehicle sensor;
an indication of a manner by which the vehicle has been driven; and
an indication of a manner by which the engine oil has been changed;
a predicted result of following the recommendation, being a first predicted result;
a predicted result of not following the recommendation, being a second predicted result;
a message including a positive remark, being a first message; and
a message including a remark identifying an improvement that can be made, being a second message; and
sending the communication from the processor to a destination.
